(19) United States
(12) Patent Application Publication
(10) Pub. No.: US 2023/0390861 A1
(43) Pub. Date: Dec. 7, 2023

(54) Low-damage Processing Device and Method for Complex Microstructure by Hybrid Laser-ultrasonic Processing in Steady Flow Area

(71) Applicant: CHANGCHUN UNIVERSITY OF SCIENCE AND TECHNOLOGY, Changchun (CN)

(72) Inventors: Jiaqi WANG, Changchun (CN); Huadong YU, Changchun (CN); Zhongxu LIAN, Changchun (CN); Jinkai XU, Changchun (CN); Guangjun CHEN, Changchun (CN); Meng HOU, Changchun (CN); Siyu XIU, Changchun (CN)

(21) Appl. No.: 18/235,396

(22) Filed: Aug. 18, 2023

Related U.S. Application Data
(63) Continuation of application No. PCT/CN2022/087807, filed on Apr. 20, 2022.

(30) Foreign Application Priority Data
May 10, 2021 (CN) 202110504610.5

(51) Int. Cl. B23K 26/00; B23K 26/352

(52) U.S. Cl. CPC B23K 26/0093; B23K 26/355

(57) ABSTRACT

A low-damage processing device for complex microstructure by hybrid laser-ultrasonic processing in a steady flow area belongs to the field of precision special processing technology, and the device includes: a base, a workpiece clamping sliding table unit, a laser unit, a jet gun unit and a host computer. The workpiece clamping sliding table unit, the laser unit and the jet gun unit are provided on the base. The laser is applied vertically to the surface of workpiece. The jet gun unit emits a high pressure water jet at an angle of 45 degrees to the surface of the workpiece. The base is provided with a waste liquid collection device. The water jet and the laser act on the workpiece surface at the same time. The present disclosure strips the recast layer of the processed surface in real time, and improves the processed quality and performance of workpiece.

### TECHNICAL FIELD

The present disclosure belongs to the field of precision special processing technology, and in particular relates to a low-damage processing device and method for complex microstructure by hybrid laser-ultrasonic processing in a steady flow area.

### BACKGROUND

With the increasing demand for micro parts in the fields including national defense, biotechnology and medicine, their processing technology has become a key focus of research in the manufacturing field. Laser etching provides an efficient, high-precision and easy-to-operate processing method, and the laser energy and optical circuit can be controlled flexibly, so it is widely used in the field of micro processing. In the traditional laser processing, the material absorbs the laser energy and produces a phase transition to achieve removal. However, the workpiece material near the laser area will also absorb a part of the heat and produce the heat-affected zone and the recast layer, resulting in the reduction of the processing performance of micro parts, so the traditional laser processing is difficult to meet the requirements of micro processing. The traditional laser processing process will also cause serious dust pollution, which seriously affects the health of operators and pollutes the working environment, so liquid-assisted laser processing emerges, including water-guided laser processing and underwater laser processing. Liquid-assisted laser processing can absorb extra heat in the processing area as well as take away chips, and liquid-assisted laser processing can reduce the generation of the heat-affected zone and the recast layer, and improve the processing quality. However, during water-guided laser processing, a water beam is incident perpendicular to the surface of the workpiece, and the water beam is coaxial with the laser. The laser energy will be attenuated and interfered by the splashing of liquid and debris, and the equipment is expensive with the high maintenance costs. In underwater laser processing, the debris suspended in the liquid and bubbles generated by the violent processing will participate in the secondary processing, affecting the processing quality. Meanwhile, the bubbles generated by a violent reaction will also interfere with the propagation of a laser beam and weaken the laser energy, which makes it difficult to meet the requirements of high-precision processing.

### SUMMARY

In order to solve the problems in the prior art, the present disclosure provides a low-damage processing device and method for complex microstructure by hybrid laser-ultrasonic processing in a steady flow area, which solves the problems of the prior art such as difficulty in meeting the requirements of micro processing and the generation of pollution.

The technical solution used in the present disclosure to solve the technical problem is as follows:

A low-damage processing device and method for complex microstructure by hybrid laser-ultrasonic processing in steady flow area, the device including: a base, a workpiece clamping sliding table unit, a laser unit, a jet gun unit and a host computer, where the workpiece clamping sliding table unit, the laser unit and the jet gun unit are provided on the base; a workpiece is clamped on the workpiece clamping sliding table unit; an optical axis of the laser emitted by the laser unit is in a horizontal state and is perpendicular to a surface of the workpiece, and a laser periodically vibrates with the optical axis as a center point on the surface of the workpiece in a direction perpendicular to the optical axis during processing; the jet gun unit emits a high pressure water jet at an acute angle to the surface of the workpiece; and the high pressure water jet and the laser in the high-frequency reciprocating motion act on the surface of the workpiece at the same time, reducing the heat-affected zone and the recast layer while stripping the attachments on the surface of the processed workpiece.

Preferably, the device further includes a shield provided outside the base, the workpiece clamping sliding table unit, the laser unit and the jet gun unit.

Preferably, the base includes: a marble and a mounting plate provided on the marble, where a peripheral baffle is assembled around the mounting plate; a waste liquid tank is located under the workpiece; and the waste liquid is discharged outside the processing device via the marble through the waste liquid tank and a drain pipe.

Preferably, the workpiece clamping sliding table unit includes: a first bending plate, an xy displacement unit, a thin rotary table, a workpiece clamping plate and a sliding table driver, where the first bending plate is mounted on the mounting plate, and the xy displacement unit is provided on the plane of the first bending plate perpendicular to the laser optical axis; the thin rotary table is provided on the plane of the xy displacement unit perpendicular to the laser optical axis, and the workpiece clamping plate is assembled on a rotating surface of the thin rotary table; and the host computer controls the motion of the xy displacement unit and the thin rotary table through the sliding table driver.

Preferably, the workpiece is fixed to the rotating surface of the thin rotary table through a pressure stud.

Preferably, the xy displacement unit adopts an oblique 45-degree layout.

Preferably, the laser unit includes: a reflector clamping seat, the laser, a second bending plate, a laser sliding table, a flexible support beam, a transducer, a first reflector, a second reflector, an emitting cylinder and a laser unit controller, where the laser is mounted outside the reflector clamping seat, the first reflector is fixed inside the reflector clamping seat by the flexible support beam provided horizontally, and the flexible support beam is provided with the transducer; the reflector clamping seat is mounted on the second bending plate, and the second bending plate reciprocates along the laser optical axis on the laser sliding table; the second bending plate is provided with the second reflector; the laser unit is an off-axis two-reflection system, and the laser is emitted from the emitting cylinder; and the laser unit controller controls the emission of the laser, and the transducer controls the flexible support beam to vibrate, thereby driving the first reflector to reciprocate up and down and achieving high frequency micro-displacement processing by the laser in a vertical direction on the workpiece.

Preferably, an outer ring of an emitting surface of the emitting cylinder is provided with a gas shield ring, connected to an external gas pipe, where the face and circumference of the gas shield ring perpendicular to the optical axis are uniformly distributed with gas holes one by one, and the gas holes are connected to each other.

Preferably, the jet gun unit includes: a third bending plate, a jet adjustment table, a jet gun base plate, a high pressure jet gun, a water storage tank, a pressure stabilizing tank, a pressure indicator and a compressor, where the third bending plate is mounted on a mounting plate, and the jet adjustment table is provided on the mounting plate; the high pressure jet gun is mounted on the jet adjustment table through the jet gun base plate; and the pressure indicator collects the pressure in the water storage tank and the pressure stabilizing tank and transmits the collected data to the host computer, and the host computer calculates a suitable pressure value, and controls the pressure of the pressure stabilizing tank and the water storage tank respectively by controlling the compressor, thereby controlling the water discharge pressure of the high pressure jet gun.

A processing method for the low-damage processing device for complex microstructure by hybrid laser-ultrasonic processing in a steady flow area, the method including the following steps:
Step I: setting in the host computer a processing trajectory and a vibration frequency of the laser unit, the pressure ejected from the high pressure jet gun and a distance of the laser from the processed workpiece;
Step II: fixing the processed workpiece on the workpiece clamping plate by the pressure stud, the host computer starting to execute the command according to the set program, the laser starting to work and reciprocating in a direction perpendicular to the optical axis driven by the transducer and the flexible support beam to realize the coupling motion of a macroscopic processing trajectory of the workpiece; meanwhile, the compressor providing the established pressure to the pressure stabilizing tank according to pressure parameters sent by the host computer, and the high pressure jet gun ejecting a water flow of a certain pressure, the use of ultra-high pressure micro-jet involved in the secondary trimming of the laser processed surface, stripping the recast layer of the processed surface, and cleaning the attachments of the
Step III: when the pressure indicator shows that the pressure cannot reach a set value, a control signal being transmitted to the host computer, and the host computer providing a set pressure value for the pressure stabilizing tank and the water storage tank by controlling the compressor; and
Step IV: during processing, the waste liquid being discharged outside the device through the waste liquid tank and the drain pipe on the mounting plate.

The beneficial effects of the present disclosure are: the present disclosure uses a high pressure water jet to participate in the secondary trimming of the laser processed surface, while reducing the heat-affected zone, the recast layer of the processed surface is stripped in real time, the attachments of the processed surface are cleaned, the quality of the processed surface and the performance of the sub-surface are improved, and the secondary processing damage is reduced; ultrasonic vibration is introduced by using a weak stiffness structure, high-frequency micro-displacement modification-coupling motion of a macroscopic processing trajectory is achieved in the direction perpendicular to the optical axis, and the requirements for complex microstructure efficient preparation are met in principle; and the surface microstructure secondary modification will also be achieved under the action of high-frequency micro-displacement in the laser micro-action area to achieve surface strengthening and improve the microstructure performance. Meanwhile, a machine tool adopts a horizontal layout, and the optical axis is placed horizontally, so that the liquid that has been involved in the processing, the chips generated during the processing, and the bubbles generated during the processing are away from the processing area faster, and do not participate in the secondary processing, thereby reducing the interference of the environment on the laser, improving the stability of the laser energy output, further improving the processing quality, and ensuring the processing accuracy. A workpiece displacement actuator adopts an oblique 45-degree layout to reduce the influence of its own load on the displacement stability, improve the execution accuracy of the motion mechanism, and ensure the stable and efficient processing process. A gas shield ring inside the laser emitting cylinder is used to remove the jet splashing residual liquid at the laser output end, further reducing the interference of the jet on the laser transmission and ensuring the stable operation of the processing.

### BRIEF DESCRIPTION OF FIGURES

FIG. 1 is a schematic structural diagram of a low-damage processing device for complex microstructure by hybrid laser-ultrasonic processing in a steady flow area according to the present disclosure.

FIG. 2 is a schematic structural diagram of a base, a workpiece clamping sliding table unit, a laser unit, and a jet gun unit of a low-damage processing device for complex microstructure by hybrid laser-ultrasonic processing in a steady flow area according to the present disclosure.

FIG. 3 is a schematic structural diagram of a laser unit of a low-damage complex microstructure by hybrid laser-ultrasonic processing in a steady flow area according to the present disclosure.

FIG. 4 is a schematic diagram of the principle of a laser unit of a low-damage complex microstructure by hybrid laser-ultrasonic processing in a steady flow area according to the present disclosure.

FIG. 5 is a schematic diagram of an xy displacement unit of a workpiece clamping sliding table unit of a low-damage complex microstructure by hybrid laser-ultrasonic processing in a steady flow area according to the present disclosure.

FIG. 6 is a schematic diagram of a gas shield ring of a laser unit of a low-damage complex microstructure by hybrid laser-ultrasonic processing in a steady flow area according to the present disclosure.

FIG. 7 is a sectional view of a gas shield ring of a laser unit of a low-damage complex microstructure by hybrid laser-ultrasonic processing in a steady flow area according to the present disclosure.

FIG. 8 is a schematic diagram of the principle of a low-damage complex microstructure by hybrid laser-ultrasonic processing in a steady flow area according to the present disclosure.

In the figures: 1, shield; 2, base; 3, fine-tuning foot; 4, workpiece clamping sliding table unit; 5, laser unit; 6, mounting plate; 7, marble; 8, peripheral baffle; 9, waste liquid tank; 10, drain pipe; 11, first bending plate; 12, xy displacement unit; 13, thin rotary table; 14, workpiece clamping plate; 15, workpiece; 16, third bending plate; 17, jet adjustment table; 18, jet gun base plate; 19, high pressure jet gun; 20, jet gun mounting rack; 21, transducer heat sink; 22, reflector clamping seat; 23, laser; 24, second bending plate; 25, shield; 26, laser sliding table; 27, laser sliding table mounting plate; 28, laser emitting cylinder; 29, flexible support beam; 30, transducer; 31, first reflector; 32, second reflector; 33, pressure stud; 34, gas pipe; and 35, gas shield ring.

### DETAILED DESCRIPTION

The present disclosure will be described in further detail below in conjunction with the accompanying drawings and examples.

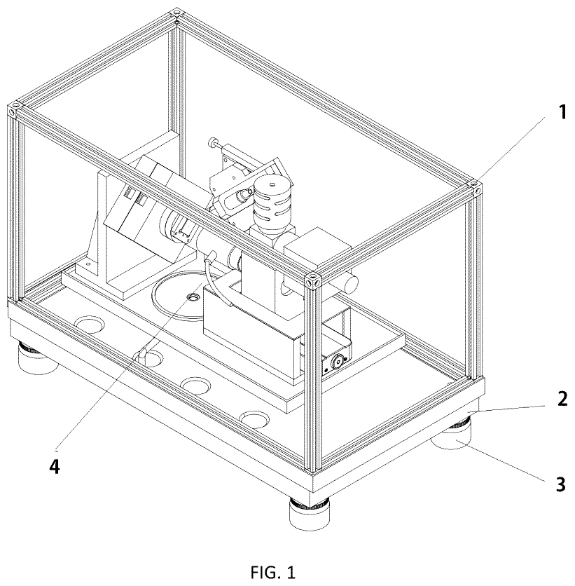

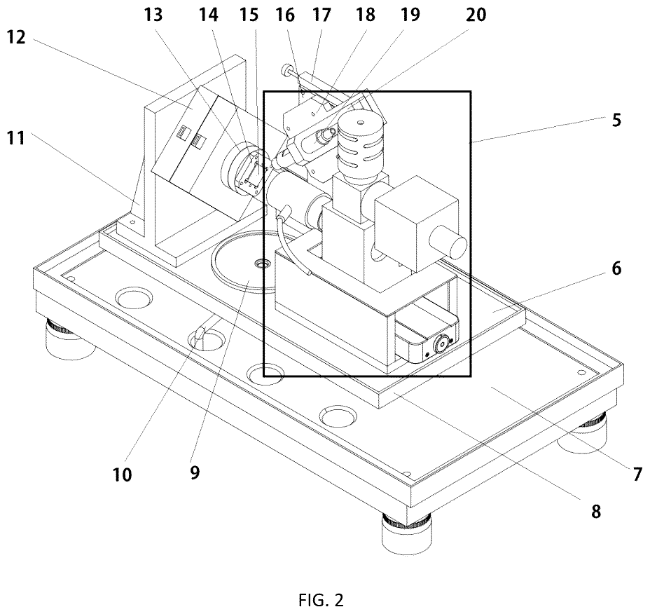

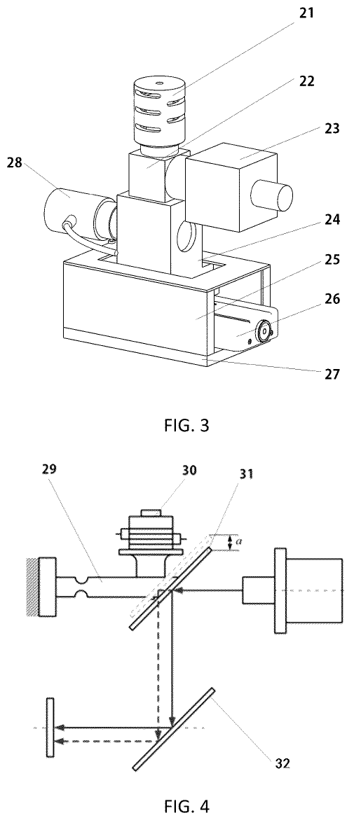

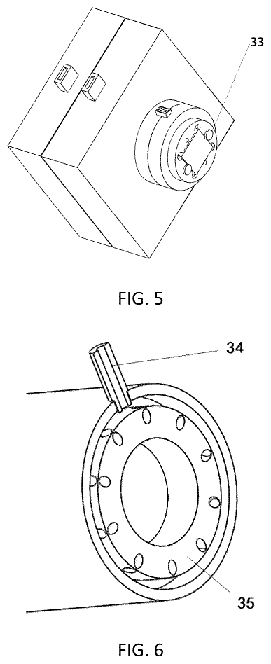

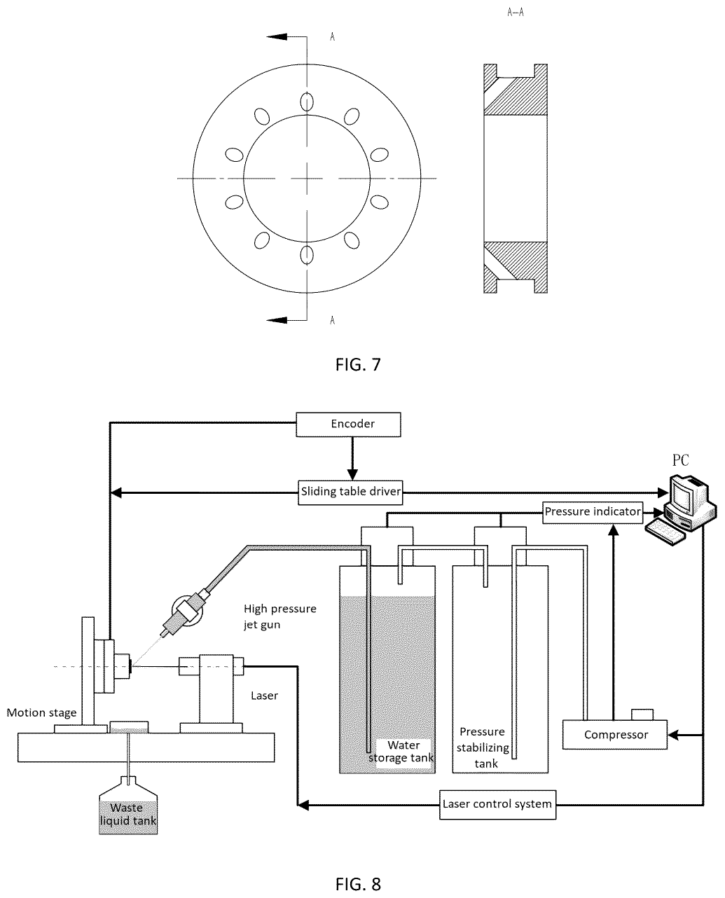

As shown in FIG. 1, a low-damage processing device for complex microstructure by hybrid laser-ultrasonic processing in a steady flow area, the device including: a base 2, a workpiece clamping sliding table unit 4, a laser unit 5, a jet gun unit and a host computer. The workpiece clamping sliding table unit 4, the laser unit 5 and the jet gun unit are provided on the base 2. Below the workpiece clamping sliding table unit 4, a waste liquid tank 9 is provided on the base 2. A workpiece 15 is clamped on the workpiece clamping sliding table unit 4. In this example, the material of the workpiece 15 is weak stiffness material. An optical axis of the laser emitted by the laser unit 5 is in a horizontal state and is perpendicular to a surface of the workpiece 15, and a laser 23 periodically vibrates with the optical axis as a center point on the surface of the workpiece in a direction perpendicular to the optical axis during processing. The jet gun unit emits a high pressure water jet at an acute angle to the surface of the workpiece 15. The high pressure water jet and the laser in the high-frequency reciprocating motion act on the surface of the workpiece 15 at the same time, reducing the heat-affected zone and the recast layer while stripping the attachments on the surface of the processed workpiece 15.

The base 2 includes: a marble 7 and a mounting plate 6 provided on the marble 7. A peripheral baffle 8 is assembled around the mounting plate 6. A waste liquid tank 9 is located under the workpiece 15. The peripheral baffle 8 prevents the waste liquid from splashing to the outside of the mounting plate 6, so that the waste liquid and attachments are discharged outside the processing device along the waste liquid tank 9 through a drain pipe 10. Holes are provided on the marble 7, and the drain pipe 10 passes through the holes to discharge the waste liquid to a waste liquid collection device.

The workpiece clamping sliding table unit 4 includes: a first bending plate 11, an xy displacement unit 12, a thin rotary table 13, a workpiece clamping plate 14 and a sliding table driver. The first bending plate 11 is fixed on the mounting plate 6, and the xy displacement unit 12 is provided on the plane of the first bending plate 11 perpendicular to the laser optical axis. The thin rotary table 13 is provided on the plane of the xy displacement unit 12 perpendicular to the laser optical axis, and the workpiece clamp plate 14 is assembled on a rotating surface of the thin rotary table 13 through a pressure stud 33. The host computer controls the motion of the xy displacement unit 12 along the X axis and the Y axis and the rotation of the thin rotary table 13 through the sliding table driver. In this example, the xy displacement unit 12 adopts an oblique 45-degree layout to reduce the influence of its own load on the displacement stability, improve the execution accuracy of the motion mechanism, and ensure the stable and efficient processing process. The laser unit 5 includes: a transducer heat sink 21, a reflector clamping seat 22, a laser 23, a second bending plate 24, a shield 25, a laser sliding table 26, a laser sliding table mounting plate 27, a laser emitting cylinder 28, a flexible support beam 29, a transducer a first reflector 31, a second reflector 32 and a laser unit controller. The laser 23 is mounted outside the reflector clamping seat 22, the first reflector 31 is fixed inside the reflector clamping seat 22 by the flexible support beam 29 provided horizontally, and the flexible support beam 29 is provided with the transducer 30. The transducer heat sink 21 is provided outside the transducer 30, so that the heat generated by the transducer 30 is dissipated as soon as possible. The reflector clamping seat 22 is mounted on an upper surface of the second bending plate 24, and the second bending plate 24 reciprocates along the laser optical axis on the laser sliding table 26. The second reflector 32 is provided in the second bending plate 24. The protective space is formed by the shield 25 and the laser sliding table mounting plate 27. An upper surface of the shield 25 is slotted. The laser sliding table 26 is provided on the laser sliding mounting plate 27. The laser unit 5 is an off-axis two-reflection system. After the laser is reflected by the first reflector 31 and the second reflector 32, it is emitted from the laser emitting cylinder 28. The laser unit controller controls the emission of the laser. The transducer 30 controls the flexible support beam 29 to vibrate vertically, thereby driving the vertical reciprocating motion of the first reflector and achieving high frequency micro-displacement processing by the laser in a vertical direction on the workpiece. In order to remove the jet splashing residual liquid at the laser output end and further reduce the interference of the jet on the laser transmission, a gas shield ring 35 is provided at the emitting end of the laser emitting cylinder 28 of the laser unit 5, which is connected to an external gas pipe. The gas shield ring is provided with corresponding gas holes one by one on the circumference and end face, and the corresponding gas holes are connected to each other. The jet gun unit includes: a third bending plate 16, a jet adjustment table 17, a jet gun base plate 18, a high pressure jet gun 19, a water storage tank, a pressure stabilizing tank, a pressure indicator and a compressor. The third bending plate 16 is mounted on a mounting plate 6, and the jet adjustment table 17 is provided on the third bending plate 16. The high pressure jet gun 19 is mounted on the jet adjustment table 17 through the jet gun base plate 18, and the distance between the high pressure jet gun 19 and the workpiece 15 can be adjusted along a water flow direction. The pressure indicator collects the pressure of the water storage tank as well as the pressure stabilizing tank and transmits the collected data to the host computer. The host computer calculates the pressure difference according to the set pressure value, and adjusts and controls the pressure of the pressure stabilizing tank and the water storage tank by controlling the compressor, so as to control the water discharge pressure of the high pressure jet gun.

In order to make the low-damage processing device for complex microstructure by hybrid laser-ultrasonic processing in a steady flow area in a horizontal state, a fine-tuning foot 3 is provided at the bottom of the marble, which is adjusted according to the expansion and contraction of the fine-tuning foot 3. In order to protect the external environment, a transparent shield 1 is provided on the exterior of the base 2, the workpiece clamping sliding table unit 4, the laser unit 5 and the jet gun unit, which cannot only prevent the waste liquid from splashing out, but also observe the working state of the processing device at any time.

A processing method for the low-damage processing device for complex microstructure by hybrid laser-ultrasonic processing in a steady flow area, the method including the following steps:
Step I: a processing trajectory and a vibration frequency of the laser unit 5, the pressure ejected from the high pressure jet gun 19 and a distance of the laser 23 from the processed workpiece 15 are set in the host computer.
Step II: the processed workpiece 15 is fixed on the workpiece clamping plate 14 by the pressure stud 33, the host computer starts to execute the command according to the set program, the laser 23 starts to work and reciprocates in a direction perpendicular to the optical axis driven by the laser sliding table 26 to realize the coupling motion of a macroscopic processing trajectory; meanwhile, the compressor provides the established pressure to the pressure stabilizing tank according to pressure parameters sent by the host computer, and the high pressure jet gun 19 ejects a water flow of a certain pressure, the use of ultra-high pressure micro-jet is involved in the secondary trimming of the laser processed surface, the recast layer of the processed surface is stripped, and the attachments of the processed surface are cleaned; and when the pressure indicator shows that the pressure cannot reach a set value, a signal is transmitted to the host computer, and the host computer provides a set pressure value for the pressure stabilizing tank and the water storage tank by controlling the compressor; and
Step III: during processing, the waste liquid is discharged outside the device through the waste liquid tank 9 and the drain pipe 10 on the mounting plate 6.

What is claimed is:

1. A low-damage processing device for complex microstructure by hybrid laser-ultrasonic processing in a steady flow area, the low-damage processing device comprising: a base, a workpiece clamping sliding table unit, a laser unit, a jet gun unit and a host computer, wherein the workpiece clamping sliding table unit, the laser unit and the jet gun unit are provided on the base; a workpiece is clamped on the workpiece clamping sliding table unit; an optical axis of the laser emitted by the laser unit is in a horizontal state and is perpendicular to a surface of the workpiece, and a laser periodically vibrates with the optical axis as a center point on the surface of the workpiece in the direction perpendicular to the optical axis during processing; the jet gun unit emits a high pressure water jet at an acute angle to the surface of the workpiece; and the high pressure water jet and the laser in the high-frequency reciprocating motion act on the surface of the workpiece at the same time, reducing the heat-affected zone and the recast layer while stripping the attachments on the surface of the processed workpiece.

2. The low-damage processing device for complex microstructure by hybrid laser-ultrasonic processing in a steady flow area according to claim 1, wherein the low-damage processing device further comprises a shield, which is provided outside the base, the workpiece clamping sliding table unit, the laser unit and the jet gun unit.

3. The low-damage processing device for complex microstructure by hybrid laser-ultrasonic processing in a steady flow area according to claim 1, wherein the base comprises: a marble and a mounting plate provided on the marble, wherein a peripheral baffle is assembled around the mounting plate; a waste liquid tank is located under the workpiece; and the waste liquid is discharged outside the processing device via the marble through the waste liquid tank and a drain pipe.

4. The low-damage processing device for complex microstructure by hybrid laser-ultrasonic processing in a steady flow area according to claim 1, wherein the workpiece clamping sliding table unit comprises: a first bending plate, an xy displacement unit, a thin rotary table, a workpiece clamping plate and a sliding table driver; wherein the first bending plate is mounted on a mounting plate, and the xy displacement unit is provided on the plane of the first bending plate perpendicular to the laser optical axis; the thin rotary table is provided on the plane of the xy displacement unit perpendicular to the laser optical axis, and the workpiece clamping plate is assembled on a rotating surface of the thin rotary table; and the host computer controls the motion of the xy displacement unit and the thin rotary table through the sliding table driver.

5. The low-damage processing device for complex microstructure by hybrid laser-ultrasonic processing in a steady flow area according to claim 4, wherein the workpiece is fixed to the rotating surface of the thin rotary table through a pressure stud.

6. The low-damage processing device for complex microstructure by hybrid laser-ultrasonic processing in a steady flow area according to claim 4, wherein the xy displacement unit adopts an oblique 45-degree layout.

7. The low-damage processing device for complex microstructure by hybrid laser-ultrasonic processing in a steady flow area according to claim 1, wherein the laser unit comprises: a reflector clamping seat, the laser, a second bending plate, a laser sliding table, a flexible support beam, a transducer, a first reflector, a second reflector, an emitting cylinder and a laser unit controller; wherein the laser is mounted outside the reflector clamping seat, the first reflector is fixed inside the reflector clamping seat by the flexible support beam provided horizontally, and the flexible support beam is provided with the transducer; the reflector clamping seat is mounted on the second bending plate, and the second bending plate reciprocates along the laser optical axis on the laser sliding table; the second bending plate is provided with the second reflector; the laser unit is an off-axis two-reflection system, and the laser is emitted from the emitting cylinder; and the laser unit controller controls the emission of the laser, and the transducer controls the flexible support beam to vibrate, thereby driving the first reflector to reciprocate up and down and achieving high frequency micro-displacement processing by the laser in a vertical direction on the workpiece.

8. The low-damage processing device for complex microstructure by hybrid laser-ultrasonic processing in a steady flow area according to claim 1, wherein an outer ring of an emitting surface of the emitting cylinder is provided with a gas shield ring, and is connected to an external gas pipe, wherein circumference and end face of the gas shield ring are uniformly distributed with corresponding gas holes one by one, and the corresponding gas holes are connected to each other.

9. The low-damage processing device for complex microstructure by hybrid laser-ultrasonic processing in a steady flow area according to claim 1, wherein the jet gun unit comprises: a third bending plate, a jet adjustment table, a jet gun base plate, a high pressure jet gun, a water storage tank, a pressure stabilizing tank, a pressure indicator and a compressor, wherein the third bending plate is mounted on a mounting plate, and the jet adjustment table is provided on the mounting plate; the high pressure jet gun is mounted on the jet adjustment table through the jet gun base plate; and the pressure indicator collects the pressure in the water storage tank and the pressure stabilizing tank and transmits the collected data to the host computer, and the host computer calculates a suitable pressure value, and controls the pressure of the pressure stabilizing tank and the water storage tank respectively by controlling the compressor, thereby controlling the water discharge pressure of the high pressure jet gun.

10. A processing method based on the low-damage processing device for complex microstructure by hybrid laser-ultrasonic processing in a steady flow area according to claim 1, the method comprising the following steps:
Step I: setting in the host computer a processing trajectory and a vibration frequency of the laser unit, the pressure ejected from the high pressure jet gun and a distance of the laser from the processed workpiece;
Step II: fixing the processed workpiece on the workpiece clamping plate by the pressure stud, executing the command on the host computer according to the set program, starting the laser to work and reciprocating in a direction perpendicular to the optical axis driven by the transducer and the flexible support beam to realize the coupling motion of a macroscopic processing trajectory of the workpiece; meanwhile, using the compressor to provide the established pressure to the pressure stabilizing tank according to pressure parameters sent by the host computer, and using the high pressure jet gun to eject a water flow of a certain pressure, using ultra-high pressure micro-jet for the secondary trimming of the laser processed surface, stripping the recast layer of the processed surface, and cleaning the attachments of the
Step III: when the pressure indicator shows that the pressure cannot reach a set value, transmitting a control signal to the host computer, and using the host computer to provide a set pressure value for the pressure stabilizing tank and the water storage tank by controlling the compressor; and
Step IV: during processing, discharging the waste liquid outside the device through the waste liquid tank and the drain pipe on the mounting plate.
